(19) United States
(12) Patent Application Publication
(10) Pub. No.: US 2026/0030033 A1
(43) Pub. Date: Jan. 29, 2026

(54) DUAL BOOT SYSTEM AND METHOD FOR DISPARATE COMPUTING PLATFORMS

(71) Applicant: Dell Products L.P., Round Rock, TX (US)

(72) Inventors: Jimmy L. Griffith, Pflugerville, TX (US); Suraj M Varma, Portland, OR (US); David Allen Dyson, Pflugerville, TX (US); Trent A. Buys, Seattle, WA (US)

(73) Assignee: Dell Products L.P., Round Rock, TX (US)

(21) Appl. No.: 18/783,499

(22) Filed: Jul. 25, 2024

(51) Int. Cl. G06F 9/4401; G06F 8/61

(52) U.S. Cl. CPC G06F 9/441; G06F 8/63

(57) ABSTRACT

Embodiments of the present disclosure provide a solution to the aforementioned problems, among others, using a seamless and secure motherboard replacement system and method that transfers context information associated with a motherboard that is being replaced to a replacement motherboard in a secure manner. According to one embodiment, an Information Handling System (IHS) with instructions, that when executed, cause the IHS to, when the IHS is being booted, detect a Central Processing Unit (CPU) architecture type of the IHS, load a boot loader from a unified bootable utility comprising a plurality of executable images each associated with a different CPU architecture type, and using the boot loader, boot one of the executable images corresponding to the detected CPU architecture type on the IHS.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

In most IHSs, low-level code is used as an intermediary between hardware components and the Operating System (OS), as well as other high-level software. In some IHSs, this low-level code is known as the Basic Input/Output System (BIOS). The BIOS provides a set of software routines that allow high-level software to interact with hardware components using standard calls. Because of certain limitations of the original BIOS, a new specification for creating code that is responsible for booting the IHS has been developed that is called the Extensible Firmware Interface (EFI) Specification, and which has been extended by the Unified Extensible Firmware Interface Forum (UEFI).

The EFI Specification describes an interface between the OS and the system firmware. In particular, the EFI Specification defines the interface that platform firmware must implement and the interface that the OS may use in booting. The EFI Specification also specifies that protocols should be provided for EFI drivers to communicate with each other. An EFI protocol is an interface definition provided by an EFI driver. The EFI core provides protocols for allocation of memory, creating events, setting the clock, and the like.

Computer motherboards typically include firmware and an associated firmware interface, such as a basic input/output system (BIOS) or unified extensible firmware interface (UEFI). Users can configure the firmware after purchase beyond the motherboard's default settings. Firmware can also be customized for various configurations or purposes. For example, a rack server may be sold to different customers in which each customer has unique configuration settings. Additionally, a vendor can preload different configurations stored in firmware in advance for different customers.

### SUMMARY

Embodiments of the present disclosure provide a solution to the aforementioned problems, among others, using a seamless and secure motherboard replacement system and method that transfers context information associated with a motherboard that is being replaced to a replacement motherboard in a secure manner. According to one embodiment, an Information Handling System (IHS) with instructions, that when executed, cause the IHS to, when the IHS is being booted, detect a Central Processing Unit (CPU) architecture type of the IHS, load a boot loader from a unified bootable utility comprising a plurality of executable images each associated with a different CPU architecture type, and using the boot loader, boot one of the executable images corresponding to the detected CPU architecture type on the IHS.

According to another embodiment, a dual booting method includes the steps of detecting a Central Processing Unit (CPU) architecture type of an Information Handling System (IHS), loading a boot loader from a unified bootable utility comprising a plurality of executable images each associated with a different CPU architecture type, and using the boot loader, booting one of the executable images corresponding to the detected CPU architecture type on the IHS.

According to yet another embodiment, a dual booting system includes an Information Handling System (IHS) with executable instructions to, when the IHS is being booted, detect a Central Processing Unit (CPU) architecture type of the HIS, load a boot loader from a unified bootable utility comprising a plurality of executable images each associated with a different CPU architecture type, and using the boot loader, boot one of the executable images corresponding to the detected CPU architecture type on the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement a dual boot system and method described herein.

FIG. 2 illustrates an example dual boot system that may be used to boot a unified bootable utility from IHSs having disparate CPU architecture types according to one embodiment of the present disclosure.

FIG. 3 illustrates an example dual boot method for booting a utility on disparate computing platforms according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Historically, IHSs with desktop and laptop form factors have had full-fledged Operating Systems (OSs) (e.g., WINDOWS, LINUX, MAC OS, etc.) executed on “X86” processors. Other types of processors, such as Advanced RISC Machine (ARM) processors, have been associated with smartphones and tablet devices, which typically carry thinner, simpler, or mobile OSs (e.g., ANDROID, IOS, WINDOWS MOBILE, etc.). In recent years, however, IHS manufacturers have started releasing desktop and laptop IHSs equipped with Advanced RISC Machine (ARM) processors, and newer OSs (e.g., WINDOWS on ARM) can now provide users with a more quintessential OS experience on those IHSs.

The inventors hereof have recognized that the IHS industry's transition from X86 to ARM-based processors has created new management, customization, optimization, interaction, servicing, and configuration opportunities for IHS users, Information Technology Decision Makers (ITDMs), and Original Equipment Manufacturers (OEMs). For example, it has been noted that many users are unaware or do not really care about the underlying technology of their computing devices (e.g., IHSs). Such an issue often yields poor user experience when attempting to boot utility software that is typically not interoperable across different platforms. That is, a bootable utility that is compatible with a X86 computing platform may not boot properly from an ARM-based platform and vice-versa. Examples of bootable utilities may include software installers, recovery programs, diagnostic applications, IHS setup or debugging applications, and the like.

Conventional techniques to create bootable utility keys across different CPU architectures have typically required a unique image for each processor architecture. Many IHS users do not understand (e.g., X86 versus ARM), hence they don't know which image they need, or why a utility works on one system but not on another. As will be described in detail herein below, embodiments of the present disclosure provide a dual boot system and method for disparate computing platforms in which a detection layer within a boot loader that would be present on all systems regardless of platform type to determine which codebase the system is compatible with (e.g., ARM or X86), and load the proper boot files according to the detected platform type.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

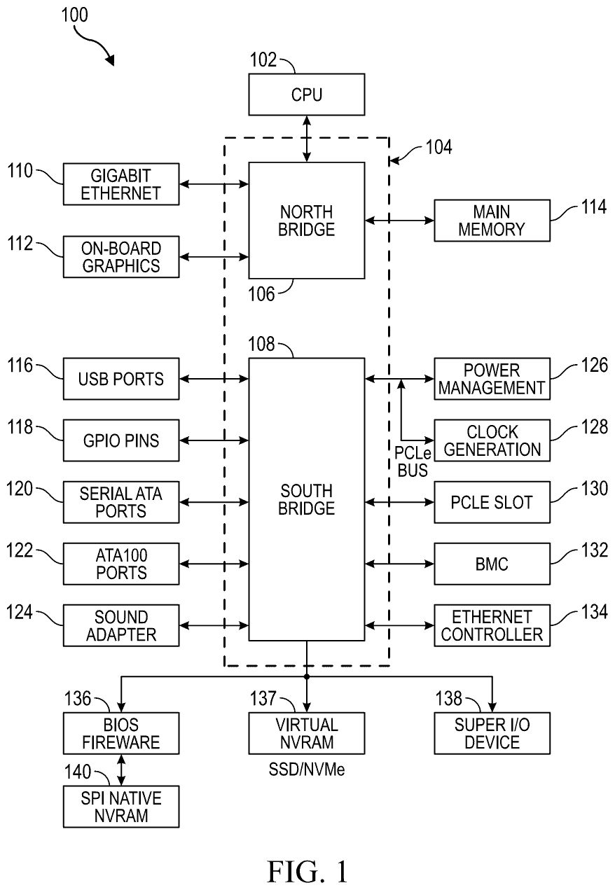

FIG. 1 shows an example of an IHS configured to implement the dual boot system and method described herein. It should be appreciated that although certain embodiments described herein may be discussed in the context of a desktop or server computer, other embodiments may be utilized with virtually any type of IHS. Particularly, the IHS includes a baseboard or motherboard 100, which is a printed circuit board (PCB) to which components or devices are mounted to by way of a bus or other electrical communication path. For example, Central Processing Unit (CPU) 102 operates in conjunction with a chipset 104. CPU 102 is a processor that performs arithmetic and logic necessary for the operation of the IHS.

Chipset 104 includes northbridge 106 and southbridge 108. Northbridge 106 provides an interface between CPU 102 and the remainder of the IHS. Northbridge 106 also provides an interface to a random access memory (RAM) used as main memory 114 in the IHS and, possibly, to on-board graphics adapter 112. Northbridge 106 may also be configured to provide networking operations through Ethernet adapter 110. Ethernet adapter 110 is capable of connecting the IHS to another IHS (e.g., a remotely located IHS) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS. Power management circuitry 126 and clock generation circuitry 128 may also be utilized during operation of southbridge 108.

Additionally, southbridge 108 is configured to provide one or more interfaces for connecting mass storage devices to the IHS. For instance, in an embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS and to transfer information between elements within the IHS. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS. The virtual NVRAM 137 may be utilized by BIOS/firmware 136 to store configuration data for the IHS. In other embodiments, configuration data for the IHS may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS. For example, BMC 132 may enable a user to discover, configure, and manage the IHS, setup configuration options, resolve and administer hardware or software problems, etc. Additionally or alternatively, BMC 132 may include one or more firmware volumes, each volume having one or more firmware files used by the BIOS' firmware interface to initialize and test components of the IHS.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS from the factory.

It should be appreciated that, in other embodiments, the IHS may comprise other types of computing devices, including hand-held computers, embedded computer systems, personal digital assistants, and other types of computing devices. It is also contemplated that the IHS may not include all of the components shown in FIG. 1, may include other components that are not explicitly shown in FIG. 1, or may utilize a different architecture.

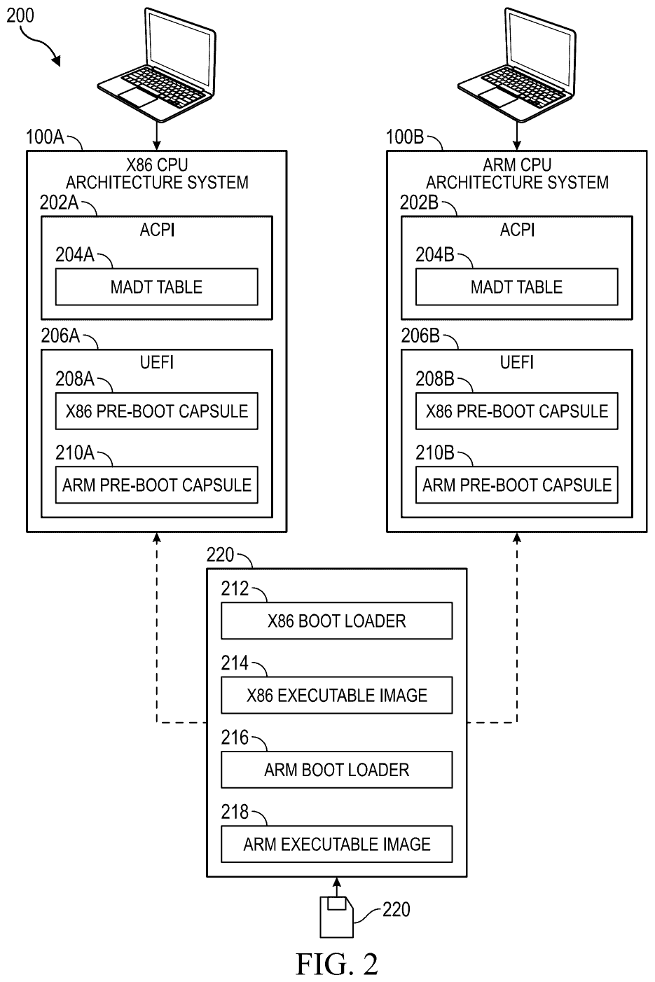

FIG. 2 illustrates an example dual boot system 200 that may be used to boot a unified bootable utility from IHSs having disparate CPU architecture types according to one embodiment of the present disclosure. The dual boot system 200 includes two IHSs 100a-b (collectively 100) with disparate CPU architectures. In one embodiment, IHS 100a may have an X86 CPU architecture while IHS 100b has an ARM CPU architecture. Nevertheless, it should be appreciated that in other embodiments that other types of CPU architectures may be used.

Each IHS 100 includes an Advanced Configuration and Power Management Interface (ACPI) module 202a-b (collectively 202) with a Multiple APIC Description Table (MADT) 204a-b (collectively 204). Additionally, each IHS 100 includes a unified extensible firmware interface (UEFI) module 206a-b configured with two pre-boot capsules, namely an X86 pre-boot capsule 208a-b (collectively 208) and an ARM pre-boot capsule 210a-b (collectively 210), one for each of the available CPU architectures. In most IHSs, low-level code is used as an intermediary between hardware components and the Operating System (OS), as well as other high-level software. In some IHSs, this low-level code is known as the Basic Input/Output System (BIOS). The BIOS provides a set of software routines that allow high-level software to interact with hardware components using standard calls. Because of certain limitations of the original BIOS, a new specification for creating code that is responsible for booting the IHS has been developed that is called the Extensible Firmware Interface (EFI) Specification, and which has been extended by the Unified Extensible Firmware Interface Forum (UEFI).

The EFI Specification describes an interface between the OS and the system firmware. In particular, the EFI Specification defines the interface that platform firmware must implement and the interface that the OS may use in booting. The EFI Specification also specifies that protocols should be provided for EFI drivers to communicate with each other. An EFI protocol is an interface definition provided by an EFI driver. The EFI core provides protocols for allocation of memory, creating events, setting the clock, and the like.

According to embodiments of the present disclosure, the capsules 208, 210 form a detection layer within their respective UEFI module 206 that would be present on all systems regardless of CPU architecture type, and will determine which codebase the system is compatible with (e.g., ARM or X86). That is, the capsules 208, 210 will be configured on some, most, or all IHSs 100 manufactured or otherwise provided by the IHS vendor. The ARM64 and X86 Pre-boot capsules 208, 210 are built and integrated into the UEFI module 206. In one embodiment, both ARM64 and X86 UEFI images will be provisioned with both of the capsules 208, 210.

A multi-architecture bootable utility 220 is provided that is configured with both an X86 executable image 214 and an ARM executable image 218 including their respective boot loaders 212, 216. When System boots the UEFI layer, the UEFI module 206 checks the MADT table 204 for the presence of an Advanced Programmable Interrupt Controller (APIC) or a Generic Interrupt Controller (GIC). The presence of the APIC indicates that the IHS 100 has an X86 CPU architecture, while the presence of the GIC indicates that the IHS 100 has an ARM CPU architecture. Either of the X86 pre-boot capsule 208 or ARM pre-boot capsule 210 are loaded based upon the detection. The loaded X86 pre-boot capsule 208 or ARM pre-boot capsule 210 will then pull the appropriate X86 executable image 214 or ARM executable image 218 for that IHS 100. The proper boot files would be chosen and the architecture specific utilities or install file would be loaded to proceed with booting the bootable utility 220.

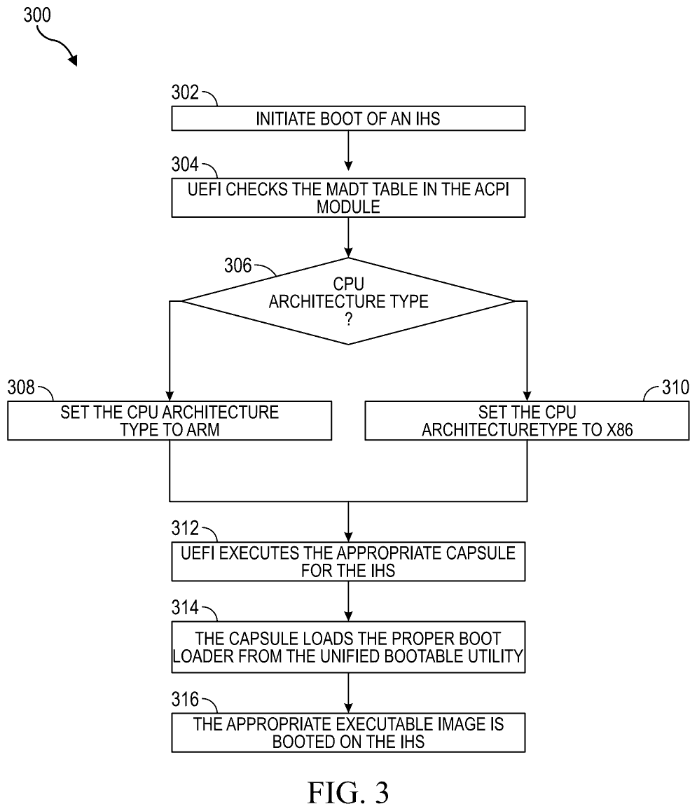

FIG. 3 illustrates an example dual boot method 300 for booting a utility on disparate computing platforms according to one embodiment of the present disclosure. Additionally or alternatively, the dual boot method 300 may be performed in whole or in part by the dual boot system 200 described above with reference to FIG. 2. The bootable utility 220 may be any suitable type. In one embodiment, the unified bootable utility 220 is an installer image configured to install an application or other type of resource or service on an IHS 100. In other embodiments, the unified bootable utility 220 may be a recovery program, a diagnostic application, an IHS setup or debug application, and the like. Initially, during UEFI development, the UEFI attribute for the CPU architecture type is defined, and the X86 pre-boot capsule 208 or ARM pre-boot capsule 210 is integrated into each IHS 100 provided by the vendor.

Later on when the user wishes to boot a unified bootable utility 220 on the IHS 100, a boot of the IHS 100 is initiated at step 302. At step 304, the UEFI 206 checks the MADT table 204 in the ACPI module 202. In one embodiment, the UEFI 206 may determine the type of CPU architecture according to whether the IHS 100 is configured with either a APIC or a GIC. An APIC indicates that the IHS 100 has an X86 CPU architecture, while a GIC indicates that the IHS 100 has an ARM CPU architecture.

At step 306, the dual boot method 300 determines the CPU architecture type. If the IHS 100 has a GIC, processing continues at step 308; otherwise, processing continues at step 310. At step 308, the dual boot method 300 sets the CPU architecture type to ARM because a GIC was detected. Otherwise, if the APIC was detected, the dual boot method 300 will set the CPU architecture type to be X86 at step 310.

At this point, the UEFI 206 is now aware of the CPU architecture type and thus at step 312, the UEFI 206 executes the appropriate capsule 208, 210. The capsule 208, 210 loads the proper boot loader 212, 216 from the unified bootable utility 220 at step 314. Thereafter, the appropriate executable image 214, 218 is booted on the IHS 100 at step 316.

The aforedescribed dual boot method 300 may be performed each time a unified bootable utility 220 is started on the IHS 100. Nevertheless, when use of the dual boot method 300 is no longer needed or desired, the process ends.

Although FIG. 3 describes an example method 300 that may be performed to boot a unified bootable utility 220 on an IHS 100, the various features of the method 300 may be embodied in other specific forms without deviating from the spirit and scope of the present disclosure. For example, the method 300 may perform additional, fewer, or different operations than those described in the present example. For another example, the method 300 may be performed in a sequence of steps different from that described above. As yet another example, certain steps of the method 300 may be performed by other components in the IHS 100 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory having program instructions stored thereon that, upon execution, cause the IHS to, when the IHS is being booted:
detect a Central Processing Unit (CPU) architecture type of the IHS;
load a boot loader from a unified bootable utility comprising a plurality of executable images each associated with a different CPU architecture type; and
using the boot loader, boot one of the executable images corresponding to the detected CPU architecture type on the IHS.

2. The IHS of claim 1, wherein the unified bootable utility comprises an image of an application to be installed on the IHS.

3. The IHS of claim 1, wherein the unified bootable utility comprises at least one of a recovery program, a diagnostic application, an IHS setup application, or a debug application.

4. The IHS of claim 1, wherein the program instructions, upon execution, further cause the IHS to detect the CPU architecture type, access a Multiple APIC Description Table (MADT) configured in a Unified Extensible Firmware Interface (UEFI) module of the IHS.

5. The IHS of claim 4, wherein the program instructions, upon execution, further cause the IHS to determine that the CPU architecture type is a X86 architecture type when the program instructions detect an Advanced Programmable Interrupt Controller (APIC) configured on the IHS.

6. The IHS of claim 4, wherein the program instructions, upon execution, further cause the IHS to determine that the CPU architecture type is an Advanced RISC Machine (ARM) architecture type when the program instructions detect a Generic Interrupt Controller (GIC) configured on the IHS.

7. The IHS of claim 1, wherein the program instructions, upon execution, further cause the IHS to detect the CPU architecture type using one or more capsules configured in the UEFI.

8. The IHS of claim 1, wherein the boot loader comprises an architecture specific boot loader associated with the detected CPU architecture type of the IHS.

9. A dual booting method comprising:
detecting a Central Processing Unit (CPU) architecture type of an Information Handling System (IHS);
loading a boot loader from a unified bootable utility comprising a plurality of executable images each associated with a different CPU architecture type; and
using the boot loader, booting one of the executable images corresponding to the detected CPU architecture type on the IHS.

10. The dual booting method of claim 9, further comprising detecting the CPU architecture type, access a Multiple APIC Description Table (MADT) configured in a Unified Extensible Firmware Interface (UEFI) module of the IHS.

11. The dual booting method of claim 10, further comprising determining that the CPU architecture type is a X86 architecture type when the program instructions detect an Advanced Programmable Interrupt Controller (APIC) configured on the IHS.

12. The dual booting method of claim 10, further comprising determining that the CPU architecture type is an Advanced RISC Machine (ARM) architecture type when the program instructions detect a Generic Interrupt Controller (GIC) configured on the IHS.

13. The dual booting method of claim 9, further comprising detecting the CPU architecture type using one or more capsules configured in the UEFI.

14. A dual booting system comprising:
an Information Handling System (IHS) comprising a processor and a memory coupled to the processor, the memory having program instructions stored thereon that, upon execution, cause the IHS to, when the IHS is being booted:
detect a Central Processing Unit (CPU) architecture type of the IHS;
load a boot loader from a unified bootable utility comprising a plurality of executable images each associated with a different CPU architecture type; and
using the boot loader, boot one of the executable images corresponding to the detected CPU architecture type on the IHS.

15. The dual booting system of claim 14, wherein the unified bootable utility comprises an image of an application to be installed on the IHS.

16. The dual booting system of claim 14, wherein the unified bootable utility comprises at least one of a recovery program, a diagnostic application, an IHS setup application, or a debug application.

17. The dual booting system of claim 14, wherein the program instructions, upon execution, further cause the IHS to detect the CPU architecture type, access a Multiple APIC Description Table (MADT) configured in a Unified Extensible Firmware Interface (UEFI) module of the IHS.

18. The dual booting system of claim 17, wherein the program instructions, upon execution, further cause the IHS to determine that the CPU architecture type is a X86 architecture type when the program instructions detect an Advanced Programmable Interrupt Controller (APIC) configured on the IHS.

19. The dual booting system of claim 17, wherein the program instructions, upon execution, further cause the IHS to determine that the CPU architecture type is an Advanced RISC Machine (ARM) architecture type when the program instructions detect a Generic Interrupt Controller (GIC) configured on the IHS.

20. The dual booting system of claim 14, wherein the program instructions, upon execution, further cause the IHS to detect the CPU architecture type using one or more capsules configured in the UEFI.
